(19) United States
(12) Patent Application Publication
(10) Pub. No.: US 2005/0228509 A1
(43) Pub. Date: Oct. 13, 2005

(54) System, device, and method for adaptively providing a fieldbus link

(76) Inventor: Robert James, Landsdale, PA (US)

Correspondence Address: Siemens Corporation;Intellectual Property Department, 170 Wood Avenue South, Iselin, NJ, 08830, US

(21) Appl. No.: 10/819,734

(22) Filed: Apr. 7, 2004

(51) Int. Cl. G05B 19/18; G06F 13/14; G05B 11/01

(52) U.S. Cl. 700/19; 700/11; 710/305

(57) ABSTRACT

Certain exemplary embodiments comprise a method in a process control system, comprising: sensing a communications protocol of a communication arriving at a gateway from a fieldbus, the gateway comprising a fieldbus interface and a communications network interface; and in response to the sensed communications protocol, automatically adapting the gateway to run a protocol stack to allow communication between the fieldbus and a communications network.

### BACKGROUND

U.S. Pat. No. 6,446,202 (Krivoshein), which is incorporated by reference herein in its entirety, allegedly cites a “configuration system for use in a process control network having a controller, a first device network that communicates using a first input/output protocol, such as a Fieldbus or a HART device protocol, and an AS-Interface device network that communicates using an AS-Interface input/output communication protocol includes a configuration database that stores configuration information pertaining to the first device network and configuration information pertaining to the AS-Interface device network, a data access routine that automatically requests configuration information pertaining to the first device network and configuration information pertaining to the AS-Interface device network and a configurator that configures the AS-Interface device network based on the AS-Interface device network configuration information. The configurator stores the AS-Interface device network configuration information in the configuration database along with configuration information pertaining to the first device network. A documentation routine accesses the configuration database to display a process control documentation schematic illustrating the configuration of the first device network and the AS-Interface device network within the process control system.”

### SUMMARY

Certain exemplary embodiments comprise a method in a process control system, comprising: sensing a communications protocol of a communication arriving at a gateway from a fieldbus, the gateway comprising a fieldbus interface and a communications network interface; and in response to the sensed communications protocol, automatically adapting the gateway to run a protocol stack to allow communication between the fieldbus and a communications network.

### BRIEF DESCRIPTION OF THE DRAWINGS

A wide variety of potential embodiments will be more readily understood through the following detailed description, with reference to the accompanying drawings in which:

FIG. 1 is a block diagram of an exemplary embodiment of system 1000;

FIG. 2 is a flow diagram of an exemplary embodiment of a method 2000; and

FIG. 3 is a block diagram of an exemplary embodiment of an information device 3000.

### DEFINITIONS

When the following terms are used herein, the accompanying definitions apply:
process control system—an industrially applied system that comprises a PLC.
programmable logic controller (PLC)—a device used to automate monitoring and/or control of an industrial plant and/or process. A PLC follows programmed instructions to provide automated monitoring and/or control functions for a machine and/or process by evaluating a set of inputs. A PLC can be applied in uses comprising materials conveying, materials pumping, materials manufacturing, electrical power generation, electrical power distribution, heating systems, ventilating systems, air conditioning systems, chemical processing, mining, machining, packaging, and/or materials distribution, etc. A PLC can be communicatively coupled with a first network of non-information devices such as sensors and/or actuators. A PLC can be communicatively coupled with a second network of information devices.
sensing—to detect or perceive automatically.
field bus—a digital, serial, multi-drop, bidirectional communications system that interconnects components of an industrial process control system and/or manufacturing automation system that includes field-based measurement and/or control devices, such as sensors, transducers, actuators, and/or controllers. A fieldbus can provide a digital replacement of the analog 4-20 milliamp interface that historically was very widely used in industrial process control.
communications protocol—a set of rules governing the formatting and/or timing of a communication.
communication—a data transmission.
gateway—a device connected to a data network for performing code and/or protocol conversion processes.
interface—(n.) a boundary across which two independent systems meet and act on or communicate with each other. (v.) to connect with or interact with by means of an interface.
communications network—a non-fieldbus network.
network—two or more information devices that are linked to share resources (such as printers or CD-ROMs), exchange files, or allow electronic communications therebetween. Information devices on a network can be linked through various wireline or wireless media, such as cables, telephone lines, power lines, optical fibers, radio waves, light beams, etc.
automatically—acting or operating in a manner essentially independent of external influence or control. For example, an automatic light switch can turn on upon “seeing” a person in its view, without the person manually operating the light switch.
bilateral—in both directions.
field devices—measurement and/or control equipment such as sensors, actuators, and/or controllers.
common—same.
physical layer—the lowest layer of the OSI model, comprising the physical hardware of the network and interfaces thereto.
OSI model—a general functional model for computer and/or data network architecture developed by the International Standards Organization (ISO). The OSI model can be logically partitioned into seven layers, namely, from lowest to highest: 1) physical layer, 2) data link layer, 3) network layer, 4) transport layer, 5) session layer, 6) presentation layer, 7) application layer. Functional equivalents to these layers are considered included in this definition.
adapting—to make suitable.
protocol stack—a collection of modules of instructions that work together to allow communications between dissimilar devices.
coupling—linking in some fashion.
physical layer—a hardware interface, e.g., RS-485.
dynamically—on demand or as necessary.
adaptively—performing differently at different times.
communicatively coupling—linking in a manner that facilitates communications.

### DETAILED DESCRIPTION

In modern process control systems, field devices can be communicatively coupled via a fieldbus to a programmable logic controller (PLC). Various fieldbus implementations can utilize similar communications architectures and identical physical layers within those architectures, yet different communications protocols for communications between the field devices and the PLC. Although field devices can be manufactured to operate under different fieldbus protocols, there can be a desire to couple those field devices to a PLC utilizing a single communications network to maintain communications consistency in a plant and reduce maintenance costs.

In certain exemplary embodiments, an adaptive gateway can communicatively couple one or more fieldbuses to a communications network that is coupled to a PLC. Any given fieldbus can utilize one communications protocol and the communications network can utilize a different communications protocol. In certain exemplary embodiments, the adaptive gateway can sense the protocol of a fieldbus and/or a communication received from or destined to that fieldbus, and can adapt to run the appropriate protocol stack to communicatively couple that fieldbus to the communications network. This capability can reduce the need to use different types of gateways to achieve the desired communications consistency. In certain embodiments, the detection of the protocol can occur at startup, and conversion can be locked to a particular protocol stack. For example, at startup, a fieldbus protocol and/or a communications network protocol can be detected and a suitable protocol stack for conversion therebetween can be selected. Alternatively, the detection can occur dynamically, thereby accommodating a protocol change after startup, and conversion can occur if and/or when needed. For example, for each communication received at the gateway, the gateway can dynamically sense the communications protocol of the communication, and, if needed, convert that communications protocol to be consistent with a destination communications protocol, such as a communications protocol of the intended recipient and/or a network coupled thereto.

Various exemplary embodiments of the adaptive fieldbus gateway can be provided in software, firmware, and/or hardware. In certain exemplary embodiments, the conversion capabilities of the adaptive fieldbus gateway can be modifiable, such as via downloading an update file to the gateway, to account for additional protocols and/or changes in existing protocols. In certain exemplary embodiments, the adaptive fieldbus gateway can interface multiple fieldbuses to a single communications network.

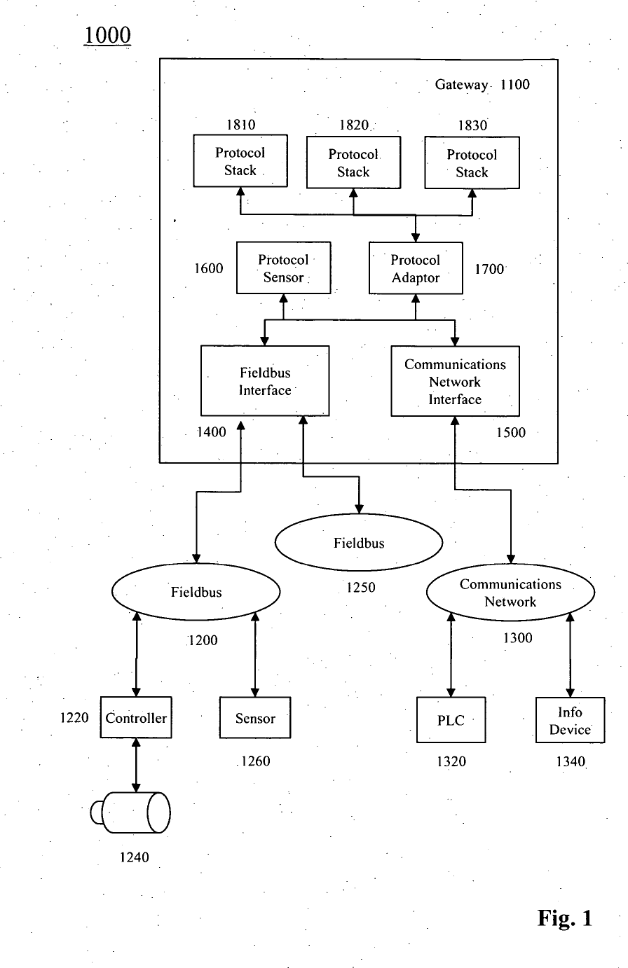

FIG. 1 is a block diagram of an exemplary embodiment of system 1000, which can comprise a gateway 1100, to which fieldbuses 1200, 1250 are connected and/or coupled, and/or a communications network 1300 connected and/or coupled to gateway 1100. Fieldbuses 1200, 1250 can be communicatively coupled to one or more field devices, such as a controller 1220 that can control a motor 1240, and/or a sensor 1260, etc. Fieldbuses 1200, 1250 can utilize any of a number of fieldbus communications protocols, including and/or excluding, for example, Profibus PA, Foundation Fieldbus H1, Foundation Fieldbus HSE, PROFInet, AS-i, Interbus, DeviceNet, HART, CAN, Modbus, Controlnet, WorldFIP, Ethernet, TCP/IP, IEEE 802.11, etc.

Communications network 1300 can be communicatively coupled to one or more PLC's 1320 and/or information devices 1340. Communications network 1300 can utilize any of a number of network communications protocols, including and/or excluding, for example, Profibus DP, Foundation Fieldbus H1, Foundation Fieldbus HSE, PROFInet, AS-i, Interbus, DeviceNet, HART, CAN, Modbus, Controlnet, WorldFIP, Ethernet, TCP/IP, IEEE 802.11, etc.

Gateway 1100 can be a fully automated device. Gateway 1100 can comprise one or more fieldbus interfaces 1400 and a communications network interface 1500. In certain embodiments, multiple fieldbus interfaces 1400 can utilize a similar and/or common physical layer, thereby allowing fieldbuses 1200, 1250 that utilize different protocols, but common physical layers, to connect to any available fieldbus interface 1400. For example, two fieldbus interfaces 1400 can utilize the same physical layer, and thus either can be physically connectable to, for example, a Profibus PA fieldbus at one time and a Foundation Fieldbus HI fieldbus at another time. As another example, a Profibus PA fieldbus and a Foundation Fieldbus HI fieldbus can both be physically connected to gateway 1100 simultaneously, and gateway can adapt to using a communication protocol stack corresponding to the Profibus PA fieldbus at one time and to the using a communication protocol stack corresponding to the Foundation Fieldbus HI fieldbus at another time.

Gateway 1100 can comprise a protocol sensor 1600 that can be configured to automatically sense a communications protocol associated with a communication. In certain exemplary embodiments, the sensed communication protocol can correspond to fieldbus 1200 or 1250. In certain exemplary embodiments, the sensed communication protocol can correspond to communications network 1300. In certain exemplary embodiments, the sensed communication protocol can correspond to a sender, transmitter, provider, upstream network, and/or incoming interface of gateway 1100, etc.

If the sensed communications protocol is different from a destination communications protocol (i.e., a communications protocol of a recipient, downstream intermediary, downstream network, and/or an outgoing interface of gateway. 1100) associated with the communication, the communication can be automatically passed to a protocol adapter 1700 that can be configured to automatically select a suitable communications protocol stack 1810, 1820, 1830 for the communication. A selected communications protocol stack 1810, 1820, 1830 can automatically convert the communication protocol of the communication from the sensed communication protocol to the destination communications protocol. Once the communications protocol of the communication has been converted, or if there is no need to convert the communications protocol, the gateway can automatically forward the communication toward the destination and/or a network coupled thereto.

Thus, gateway 1100 can communicatively couple the fieldbus to the communications network. In certain exemplary embodiments, gateway 1100 can convert the protocol of multiple communications simultaneously and/or near simultaneously, using, for example, time-slicing, channelization, multiplexing, distributed processing, and/or parallel processing, etc., techniques.

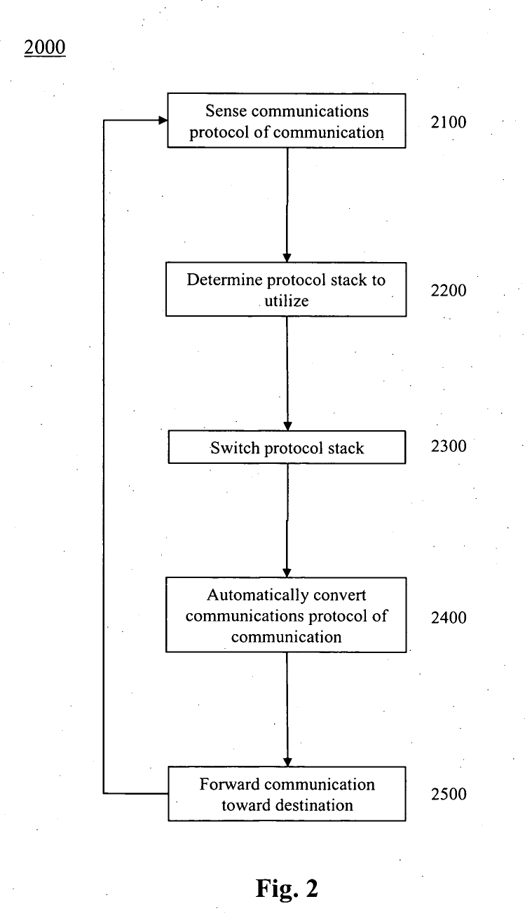

FIG. 2 is a flow diagram of an exemplary embodiment of an automated method 2000, which can be implemented via a gateway as described herein. At activity 2100, a communications protocol of a communication can be sensed. At activity 2200, a determination can be made regarding what protocol stack, if any, to apply to the communication. At activity 2300, the protocol stack can be switched from a previous (or first) stack to a current (or second) stack that corresponds to a current communication, its destination, and/or an outgoing interface of the gateway. At activity 2400, the communications protocol of the communication can be automatically converted to a communications protocol corresponding to the destination of the communication, and/or to an outgoing interface of the gateway. At activity 2500, the converted communication can be forwarded toward its destination and/or can be transmitted from an outgoing interface of the gateway.

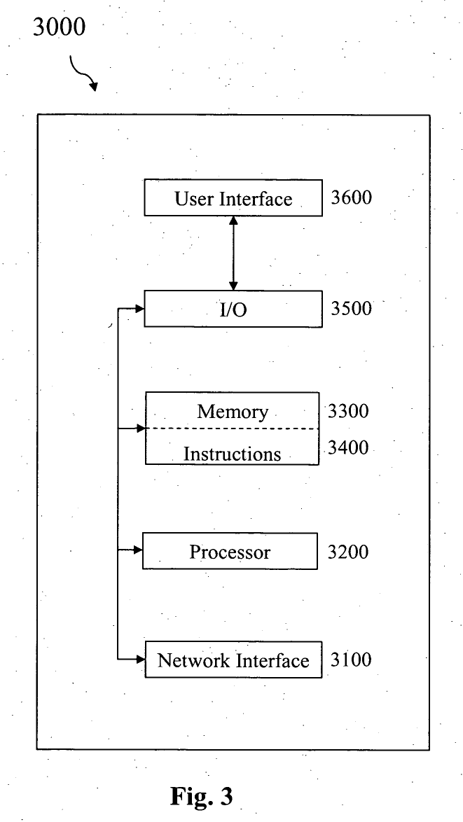

FIG. 3 is a block diagram of an exemplary embodiment of an information device 3000, which can represent any of gateway 1100, PLC 1320, and/or information device 1340, etc. of FIG. 1. Information device 3000 can comprise any of numerous well-known components, such as for example, one or more network interfaces 3100, one or more processors 3200, one or more memories 3300 containing instructions 3400, one or more input/output (I/O) devices 3500, and/or one or more user interfaces 3600 coupled to I/O device 3500, etc.

As used herein, the term “information device” means any device capable of processing information, such as any general purpose and/or special purpose computer, such as a personal computer, workstation, server, minicomputers mainframe, supercomputer, computer terminal, laptop, wearable computer, and/or Personal Digital Assistant (PDA), mobile terminal, Bluetooth device, communicator, “smart” phone (such as a Handspring Treo-like device), messaging service (e.g., Blackberry) receiver, pager, facsimile, cellular telephone, a traditional telephone, telephonic device, a programmed microprocessor or microcontroller and/or peripheral integrated circuit elements, an ASIC or other integrated circuit, a hardware electronic logic circuit such as a discrete element circuit, and/or a programmable logic device such as a PLD, PLA, FPGA, or PAL, or the like, etc. In general any device on which resides a finite state machine capable of implementing at least a portion of a method, structure, and/or or graphical user interface described herein may be used as an information device. An information device can include well-known components such as one or more network interfaces, one or more processors, one or more memories containing instructions, and/or one or more input/output (I/O) devices, one or more user interfaces, etc.

As used herein, the term “processor” means a device for processing machine-readable instruction. A processor can be a central processing unit, a local processor, a remote processor, parallel processors, and/or distributed processors, etc. The processor can be a general-purpose microprocessor, such the Pentium III series of microprocessors manufactured by the Intel Corporation of Santa Clara, Calif. In another embodiment, the processor can be an Application Specific Integrated Circuit (ASIC) or a Field Programmable Gate Array (FPGA) that has been designed to implement in its hardware and/or firmware at least a part of an embodiment disclosed herein.

As used herein, a “memory device” means any hardware element capable of data storage, such as for example, a non-volatile memory, volatile memory, Random Access Memory, RAM, Read Only Memory, ROM, flash memory, magnetic media, a hard disk, a floppy disk, a magnetic tape, an optical media, an optical disk, a compact disk, a CD, a digital versatile disk, a DVD, and/or a raid array, etc.

As used herein, the term “firmware” means machine-readable instructions that are stored in a read-only memory (ROM). ROM's can comprise PROMs and EPROMs.

As used herein, the term “I/O device” means any sensory-oriented input and/or output device, such as an audio, visual, haptic, olfactory, and/or taste-oriented device, including, for example, a monitor, display, projector, overhead display, keyboard, keypad, mouse, trackball, joystick, gamepad, wheel, touchpad, touch panel, pointing device, microphone, speaker, video camera, camera, scanner, printer, haptic device, vibrator, tactile simulator, and/or tactile pad, potentially including a port to which an I/O device can be attached or connected.

As used herein, the term “haptic” means both the human sense of kinesthetic movement and the human sense of touch. Among the many potential haptic experiences are numerous sensations, body-positional differences in sensations, and time-based changes in sensations that are perceived at least partially in non-visual, non-audible, and non-olfactory manners, including the experiences of tactile touch (being touched), active touch, grasping, pressure, friction, traction, slip, stretch, force, torque, impact, puncture, vibration, motion, acceleration, jerk, pulse, orientation, limb position, gravity, texture, gap, recess, viscosity, pain, itch, moisture, temperature, thermal conductivity, and thermal capacity.

As used herein, the term “user interface” means any device for rendering information to a user and/or requesting information from the user. A user interface includes at least one of textual, graphical, audio, video, animation, and/or haptic elements. A textual element can be provided, for example, by a printer, monitor, display, projector, etc. A graphical element can be provided, for example, via a monitor, display, projector, and/or visual indication device, such as a light, flag, beacon, etc. An audio element can be provided, for example, via a speaker, microphone, and/or other sound generating and/or receiving device. A video element or animation element can be provided, for example, via a monitor, display, projector, and/or other visual device. A haptic element can be provided, for example, via a very low frequency speaker, vibrator, tactile stimulator, tactile pad, simulator, keyboard, keypad, mouse, trackball, joystick, gamepad, wheel, touchpad, touch panel, pointing device, and/or other haptic device, etc.

A user interface can include one or more textual elements such as, for example, one or more letters, number, symbols, etc. A user interface can include one or more graphical elements such as, for example, an image, photograph, drawing, icon, window, title bar, panel, sheet, tab, drawer, matrix, table, form, calendar, outline view, frame, dialog box, static text, text box, list, pick list, pop-up list, pull-down list, menu, tool bar, dock, check box, radio button, hyperlink, browser, button, control, palette, preview panel, color wheel, dial, slider, scroll bar, cursor, status bar, stepper, and/or progress indicator, etc. A textual and/or graphical element can be used for selecting, programming, adjusting, changing, specifying, etc. an appearance, background color, background style, border style, border thickness, foreground color, font, font style, font size, alignment, line spacing, indent, maximum data length, validation, query, cursor type, pointer type, autosizing, position, and/or dimension, etc. A user interface can include one or more audio elements such as, for example, a volume control, pitch control, speed control, voice selector, and/or one or more elements for controlling audio play, speed, pause, fast forward, reverse, etc. A user interface can include one or more video elements such as, for example, elements controlling video play, speed, pause, fast forward, reverse, zoom-in, zoom-out, rotate, and/or tilt, etc. A user interface can include one or more animation elements such as, for example, elements controlling animation play, pause, fast forward, reverse, zoom-in, zoom-out, rotate, tilt, color, intensity, speed, frequency, appearance, etc. A user interface can include one or more haptic elements such as, for example, elements utilizing tactile stimulus, force, pressure, vibration, motion, displacement, temperature, etc.

In certain exemplary embodiments, via one or more user interfaces 3600, such as a graphical user interface, a user can program gateway 1100 and/or initiate a communication that can be converted by gateway 1100.

Still other embodiments will become readily apparent to those skilled in this art from reading the above-recited detailed description and drawings of certain exemplary embodiments. It should be understood that numerous variations, modifications, and additional embodiments are possible, and accordingly, all such variations, modifications, and embodiments are to be regarded as being within the spirit and scope of the appended claims. For example, regardless of the content of any portion (e.g., title, field, background, summary, abstract, drawing figure, etc.) of this application, unless clearly specified to the contrary, there is no requirement for the inclusion in any claim of the application of any particular described or illustrated activity or element, any particular sequence of such activities, or any particular interrelationship of such elements. Moreover, any activity can be repeated, any activity can be performed by multiple entities, and/or any element can be duplicated. Further, any activity or element can be excluded, the sequence of activities can vary, and/or the interrelationship of elements can vary. Accordingly, the descriptions and drawings are to be regarded as illustrative in nature, and not as restrictive. Moreover, when any number or range is described herein, unless clearly stated otherwise, that number or range is approximate. When any range is described herein, unless clearly stated otherwise, that range includes all values therein and all subranges therein. Any information in any material (e.g., a United States patent, United States patent application, book, article, etc.) that has been incorporated by reference herein, is only incorporated by reference to the extent that no conflict exists between such information and the other statements and drawings set forth herein. In the event of such conflict, including a conflict that would render a claim invalid, then any such conflicting information in such incorporated by reference material is specifically not incorporated by reference herein.

1. A method, comprising:
sensing a fieldbus communications protocol of a communication arriving at a gateway from a fieldbus, the gateway comprising a fieldbus interface and a communications network interface, the sensed fieldbus communications protocol being one of a plurality of protocols; and
in response to the sensed fieldbus communications protocol, automatically converting the sensed fieldbus communications protocol to a communications network protocol to allow bilateral communication between the fieldbus and a communications network.

2. The method of claim 1, wherein the sensed fieldbus communications protocol is a Profibus PA protocol.

3. The method of claim 1, wherein the sensed fieldbus communications protocol is a Foundation Fieldbus H1 protocol.

4. The method of claim 1, wherein the communications network operates under a Profibus DP protocol.

5. The method of claim 1, wherein the sensed communications protocol is converted to a Profibus DP protocol for communicating on the communications network.

6. The method of claim 1, wherein the fieldbus interface is in communication with a plurality of field devices, each field device from the plurality of field devices utilizing a common physical layer.

7. The method of claim 1, wherein the fieldbus interface is in communication with a plurality of field devices, each field device from the plurality of field devices utilizing a common physical layer, the fieldbus interface using one of a plurality of different fieldbus communications protocols for each field device.

8. The method of claim 1, wherein the fieldbus interface is in communication with a plurality of field devices, each field device from the plurality of field devices utilizing a common physical layer, the fieldbus interface using one of a plurality of different fieldbus communications protocols for each field device, and further comprising converting each of the fieldbus communications protocols to the communications network protocol to allow bilateral communications between the plurality of field devices and the communication network.

9. A method in a process control system, comprising:
sensing a communications protocol of a communication arriving at a gateway from a fieldbus, the gateway comprising a fieldbus interface and a communications network interface; and
in response to the sensed communications protocol, automatically adapting the gateway to run a protocol stack to allow communication between the fieldbus and a communications network.

10. The method of claim 9, wherein the gateway is operative to conduct bilateral communication between the fieldbus and the communications network.

11. The method of claim 9, further comprising converting the sensed communications protocol to a network communications protocol.

12. The method of claim 9, wherein the sensed communications protocol is a Profibus PA protocol.

13. The method of claim 9, wherein the sensed communications protocol is a Foundation Fieldbus H1 protocol.

14. The method of claim 9, wherein the communications network operates under a Profibus DP protocol.

15. The method of claim 9, wherein the sensed communications protocol is converted to a Profibus DP protocol for communicating on the communications network.

16. The method of claim 9, wherein the fieldbus interface is in communication with a plurality of field devices, each of the plurality of field devices using a different fieldbus communications protocol, and further comprising converting each of the fieldbus communications protocols into a Profibus DP network communications protocol.

17. A method in a process control system, comprising the activities of:
sensing a communications protocol of a communication arriving at a gateway from a fieldbus, the gateway comprising a physical layer fieldbus interface and a physical layer network interface; and
in response to the sensed communications protocol, autommatically adapting the gateway to run a protocol stack to convert the sensed communications protocol to a network protocol so as to allow communication between the fieldbus and a communications network.

18. The method of claim 17, wherein the gateway is operative to conduct bilateral communication between the fieldbus and the communications network.

19. The method of claim 17, wherein the sensed communications protocol is a Profibus PA protocol.

20. The method of claim 17, wherein the sensed communications protocol is a Foundation Fieldbus H1 protocol.

21. The method of claim 17, wherein the communications network operates under a Profibus DP protocol.

22. The method of claim 17, wherein the gateway is in communication with a plurality of field devices, each of the plurality of field devices using a different fieldbus protocol and further comprising converting each of the fieldbus protocols from each of the field devices into a Profibus DP protocol.

23. A system, comprising:
a gateway connected to a fieldbus and to a communications network;
a protocol sensor configured to sense a communications protocol associated with communications coming from devices on the fieldbus; and
a protocol adaptor configured to, in response to the sensed fieldbus communications protocol, automatically adapt the gateway to run a protocol stack to allow bilateral communication between the fieldbus and the communications network.

24. A machine readable medium containing instructions for activities comprising:
sensing a communications protocol of a communication arriving at a gateway from a fieldbus, the gateway comprising a fieldbus interface and a communications network interface; and
in response to the sensed fieldbus communications protocol, automatically adapting the gateway to run a protocol stack to allow bilateral communication between the fieldbus and a communications network.

25. A method in a process control system, comprising the activities of:
sensing a communications protocol of a communication arriving at a gateway from a first fieldbus from a plurality of fieldbuses, the gateway coupled to the plurality of fieldbuses; and
in response to the sensed communications protocol, automatically adapting the gateway to run a protocol stack to convert the sensed communications protocol to a network protocol so as to allow communication between the first fieldbus and a communications network.
